(19) United States
(12) Patent Application Publication
(10) Pub. No.: US 2014/0378758 A1
(43) Pub. Date: Dec. 25, 2014

(54) Multi-Furcated Tine Erotic Stimulation Device

(71) Applicant: Terri Mankin, Warsaw, OH (US)

(72) Inventor: Terri Mankin, Warsaw, OH (US)

(21) Appl. No.: 14/311,273

(22) Filed: Jun. 21, 2014

Related U.S. Application Data
(60) Provisional application No. 61/837,941, filed on Jun. 21, 2013.

(51) Int. Cl. A61H 19/00

(52) U.S. Cl. CPC A61H 19/44
USPC 600/38

(57) ABSTRACT

An erotic stimulation device for a human body cavity resembles a deer antler. The penetrative vibrator includes a beam member extending in a generally arcuate manner between a first end and a second end, first, second and third tine members spaced apart along the beam member and each outwardly extending from the beam member, and a vibrating device operably coupled to the beam member to selectively vibrate the beam member and the tine members. At least a portion of the beam member at the second end of the beam member and each of the tine members are configured for being received by the human body cavity. The beam member and the tine members are configured to resemble a deer antler and a portion of the beam member at the second end of the beam member and each of the tine members are configured to each resemble a human penis.

### CROSS-REFERENCE TO RELATED APPLICATIONS

This application claims priority from U.S. Provisional Patent Application No. 61/837,941 filed on Jun. 21, 2013, the disclosure of which is expressly incorporated herein in its entirety by reference

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to erotic stimulation devices and methods and, more particularly, to erotic stimulation devices and methods utilizing the appearance of naturally occurring objects such as deer antlers.

### BACKGROUND OF THE INVENTION

Deer antlers are considered trophies by many deer hunters. Deer hunters most desire deer antlers that have at least eight tines. When antlers have more than eight tines, their desirability increases greatly. Ordinarily deer hunters choose to display their collections by mounting them on a wall in their home or other desired congregational location. Colloquially, a rack of deer antlers having eight tine members extending therefrom is known as an eight point buck. FIG. 1 illustrates an exemplary naturally occurring set of antlers from an eight-point white-tailed deer. It should be noted that antlers vary somewhat from deer to dear and vary between different varieties of deer and other animals.

Erotic stimulation devices or sex toys may consist of uniquely designed items that purposefully arouse or sexually stimulate a receiving person when the sex toy engages an erogenous zone of the receiver. Many sex toy owners proudly display their toys as works of art.

Accordingly, a need exists for a device and/or method that combines the desirability of displaying deer antlers and the desirability of displaying sex toys. Further, a need exists for an improved sex toy that has a shape naturally occurring in the animal kingdom. The present invention addresses these and other needs.

### SUMMARY OF THE INVENTION

Disclosed are erotic stimulation devices and methods which address one or more issues of the related art. Disclosed is an erotic stimulation device comprising, in combination, a beam member at least partially extending in a generally arcuate manner between a first end and a second end, and a plurality of tine members spaced apart along the beam member between the first and second ends of the beam member and each outwardly extending from the beam member. The beam member and the plurality of tine members are configured to resemble a deer antler.

Also disclosed is a penetrative vibrator for insertion into a human body cavity comprising, in combination, a beam member at least partially extending in a generally arcuate manner between a first end and a second end, a plurality of tine members spaced apart along the beam member between the first and second ends of the beam member and each outwardly extending from the beam member, and a vibrating device operably coupled to the beam member to selectively vibrate the beam member. The beam member and each of the plurality of tine members are configured for being received by the human body cavity.

Also disclosed is a penetrative vibrator for insertion into a human body cavity comprising, in combination, a beam member at least partially extending in a generally arcuate manner between a first end and a second end, first, second and third tine members spaced apart along the beam member between the first and second ends of the beam member and each outwardly extending from the beam member, and a vibrating device operably coupled to the beam member to selectively vibrate the beam member and the first, second, and third tine members. At least a portion of the beam member at the second end of the beam member and each of the first, second and third tine members are configured for being received by the human body cavity. The beam member and the first, second and third tine members are configured to resemble a deer antler and at least a portion of the beam member at the second end of the beam member and each of the first, second, and third tine members are configured to each resemble a human penis.

From the foregoing disclosure and the following more detailed description of various preferred embodiments it will be apparent to those skilled in the art that the present invention provides a significant advance in the technology and art of erotic stimulation devices. Particularly significant in this regard is the potential the invention affords for providing a relatively effective, versatile, and easy to use erotic stimulation device which can also be displayed as a piece of art. Additional features and advantages of various preferred embodiments will be better understood in view of the detailed description provided below.

### BRIEF DESCRIPTION OF THE DRAWINGS

These and further features of the present invention will be apparent with reference to the following description and drawings.

FIG. 1 is a diagrammatic view of a pair of naturally occurring antlers of a white-tailed deer.

FIG. 2 is a left side view of a multi-furcated tine member erotic stimulation device according to the present invention, wherein the right side is a mirror image thereof.

FIG. 3 is a bottom view of the erotic stimulation device of FIG. 2.

FIG. 4 is a top view of the erotic stimulation device of FIGS. 2 and 3.

FIG. 5 is a front view of the erotic stimulation device of FIGS. 2 to 4.

FIG. 6 is a rear view of the erotic stimulation device of FIGS. 2 to 5.

FIG. 7 is a schematic view of a vibration mechanism of the erotic stimulation device of FIGS. 2 to 6.

It should be understood that the appended drawings are not necessarily to scale, presenting a somewhat simplified representation of various preferred features illustrative of the basic principles of the invention. The specific design features of the erotic stimulation devices disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the erotic stimulation devices illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the erotic stimulation devices and methods disclosed herein. The following detailed discussion of various alternative and preferred embodiments will illustrate the general principles of the invention. However, other embodiments suitable for other applications will be apparent to those skilled in the art given the benefit of this disclosure.

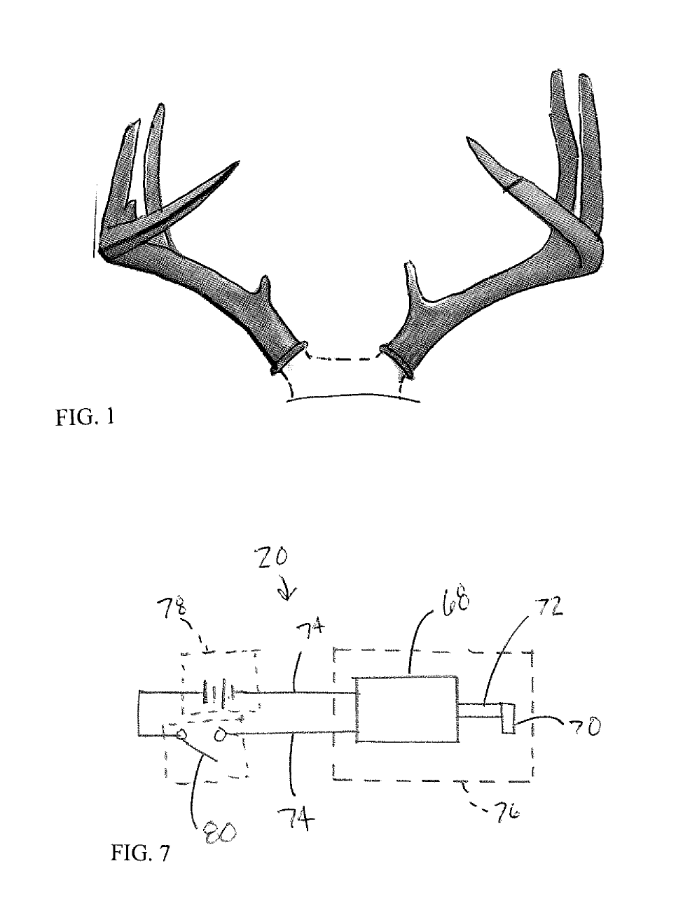

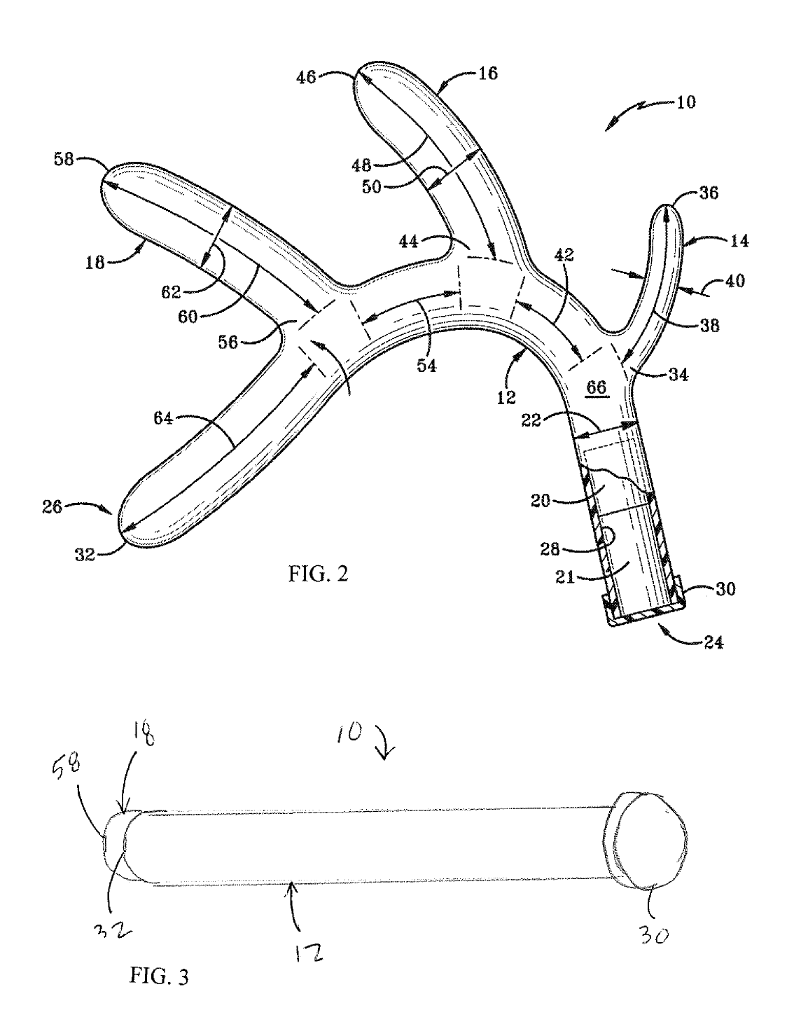

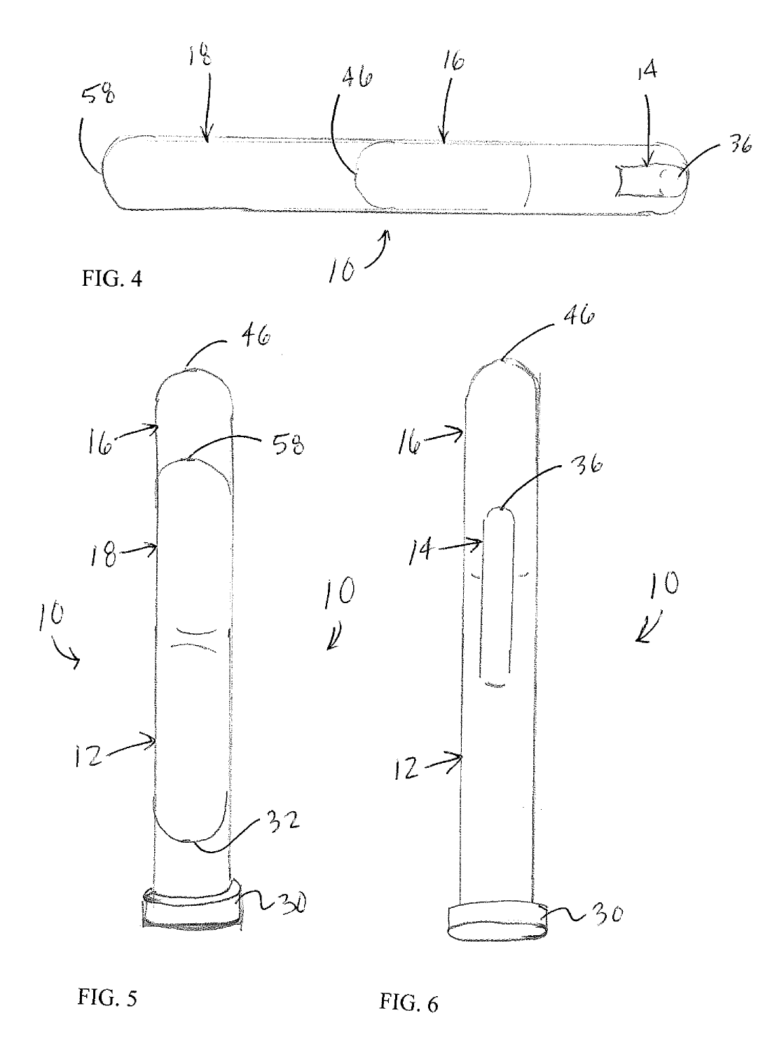

FIGS. 2 to 6 illustrate an erotic or sexual stimulation device or sex toy according to the present invention. The illustrated erotic stimulation device is a multi-furcated tine member erotic stimulating device 10 that includes a main beam or beam member 12 at least partially extending in a generally arcuate manner between a first or pedicle end 24 and a second or tip end, and a plurality of tine or phallic members 14, 16, 18 spaced apart along the length of the beam member 12 between the first and second ends of the beam member 12 and each outwardly extending from the beam member 12. The illustrated plurality of tine members 14. 16, 18 all extend from the same side of the beam member 12. The illustrated beam member 12 and the plurality of tine members 14, 16, 18 are configured to resemble a naturally occurring antler of a white-tailed deer. FIG. 1 illustrates an exemplary naturally occurring set of antlers from an eight-point white-tailed deer. It should be noted that antlers vary somewhat from deer to deer and vary between different varieties of deer and other animals. It is noted that the erotic stimulation device can alternatively be configured to resemble a different antler shape (such as, for example, a six point buck, a ten point buck or a twelve point buck), an antler from a different type of deer (such as, for example, a mule deer), a different type of animal (such as, for example, a moose or antelope), or a different type of naturally occurring object. At least a portion of the illustrated beam member 12 at the tip end 26 of the beam member 12 and each of the illustrated plurality of tine members 14, 16, 18 are configured to each resemble a phallus or human male sexual member (i.e., penis). The illustrated erotic stimulation device 10 is in the form of a penetrative vibrator for a human body cavity and includes a vibrating device 20 operably coupled to the beam member 12 to selectively vibrate the beam member 12 and the plurality of tine members 14, 16, 18. It is noted, however, that the vibration device 20 can be eliminated if desired.

The illustrated main beam or beam member 12 is a generally cylindrical body having a length extending from the first or pedicle end 24 to the second or tip end 26. The length of the beam member 12 can be in the range of 22 inches to about 36 inches and preferably is about 29 inches. The illustrated beam member 12 has circular-shaped cross section along its entire length and has a suitable diameter 22 for being pleasurably received by a human body cavity such as, for example, a vagina or rectum. The diameter 22 of the beam member 12 can be in the range of about ½ inch and about 3 inches. Preferably, however, the diameter 22 of the beam member 12 mimics the diameter of an average human penis which is in the range of about 1 inch to about 2 inches. It is noted that the beam member 12 can alternatively have any other suitable sizes and/or shapes such as, for example, different cross sections, different diameters, different lengths, and the like.

The illustrated tip end 26 of the beam member 12 has a rounded or hemispheric shape 32. The hemispheric shape 32 promotes insertion into the human body cavity and eases extraction. For example, in combination with a vagina, the hemispheric-shaped tip end 26 will be aligned with the vaginal opening. A user may selectively breach the vaginal opening and insert the tip end 26 into the vaginal cavity. The hemispheric shape 32 pleasurably and ergonomically promotes insertion into the vagina, as it is similar to the end of an ordinary phallus or human male sexual member (i.e., penis). It is noted that the tip end 26 of the beam member 12 can alternatively have any other suitable size and/or shape. For example, the tip end 26 of the beam member 12 may be engorged or bulbous to provide a larger diameter or there here may be a ball or head attached to the tip end 26 to further simulate the appearance of a human penis.

The illustrated beam member 12 extends in a generally arcuate manner from the pedicle end 24 to the tip end 26. The illustrated beam member 12 has a first portion that is substantially straight and extends from the pedicle end 24 to the first tine member 14, a second portion that is arcuate or curved and extends from the first tine member 14 to the third tine member 18, and a third portion that is arcuate or curved in a direction opposite from that of the second portion and extends from the third tine member 18 to the tip end 26. The second portion has a length and radius of curvature such that the beam member 12 is curved at least 90 degrees and the illustrated second portion has a length and radius of curvature such that the beam member 12 is curved more 90 degrees. The illustrated third portion has a radius of curvature that is less than the radius of curvature of the second portion. The illustrated beam member 12 has a simple arc or curve in that the longitudinal axis of the beam member 12 is in a single plane. It is noted, however, that the beam member 12 can alternatively have a complex arc or curve where the longitudinal axis is not in a single plane such as a naturally occurring white-tailed deer antler (best shown in FIG. 1). It is also noted that the beam member 12 can alternatively have any other suitable sizes and/or shapes such as, for example, substantially straight, complex curved, or the like.

The illustrated beam member 12 is substantially solid or non-hollow except for a hollow cavity or chamber 28 formed within the beam member 12 at the pedicle end 24. The illustrated chamber 28 is sized and shaped to receive and enclose the vibrating device 20. The illustrated chamber 28 is closed and sealed by a removably secured cap 30 but can alternatively be closed and sealed in any other suitable manner such as, for example, a plug, door, and the like. It is noted that the beam member 12 can alternatively be formed in any other suitable manner.

The illustrated first tine or phallic member 14 is a generally cylindrical body having a length 38 extending from the first or base end 34 at the beam member 12 to the second or tip end 36. The first tine member 14 furcates or splits from the beam member 12 at the base end 34 and extends outward from the beam member 12 longitudinally towards the tip end 36. The illustrated first tine member 14 forms an acute angle with the beam member 12 so that the first tine member 14 angles away from the pedicle end 24 of the beam member 12 and angles toward the tip end of the beam member 12. The length of the first tine member 14 is preferably less than the length of the second tine member 16, and the length of the third tine member 18. The length of the first tine member 14 can be in the range from about 2 inches to about 4 inches and the illustrated first tine member has a length of about 3 inches. This shorter first tine member 14 simulates the first short tine ordinarily found on a typical naturally occurring deer antler (best shown in FIG. 1). The illustrated first tine member 14 has circular-shaped cross section along its entire length 38 and has a suitable diameter 40 for being pleasurably received by a human body cavity such as, for example, a vagina or rectum. The diameter 40 of the first tine member 14 is preferably less than the diameter 22 of the beam member 12 and can be in the range of about ¼ inch and about 2 inches. Preferably, the diameter 40 of the first tine member is similar to or less than the diameter of an average human penis which is in the range of about 1 inch to about 2 inches. It is noted that the first tine member 14 can alternatively have any other suitable sizes and/or shapes such as, for example, different cross sections, different diameters, different lengths, or the like.

The illustrated tip end 36 of the first tine member 14 has a rounded or hemispheric shape. The hemispheric shape promotes insertion into the human body cavity and eases extraction. It is noted that the tip end 36 of the first tine member 14 can alternatively have any other suitable size and/or shape. For example, the tip end 36 of the first tine member 14 may be engorged or bulbous to provide a larger diameter or there here may be a ball or head attached to the tip end 36 to further simulate the appearance of a human penis.

The illustrated first tine member 14 extends in a generally arcuate manner from the base end 34 at the beam member 12 to the tip end 36. The illustrated first tine member 14 has a radius of curvature that is less than the radius of curvature of the second tine member 16 and less than the radius of curvature of the third tine member 18. The illustrated first tine member 14 has a simple arc or curve in that the longitudinal axis of the first tine member 14 is in a single plane and it is in the same plane as the main beam. It is noted, however, that the first tine member 14 can alternatively have a complex arc or curve where the longitudinal axis is not in a single plane and/or can be in a different plane of curvature than the beam member 12. It is also noted that the first tine member 14 can alternatively have any other suitable sizes and/or shapes such as, for example substantially straight, complex curved, or the like.

The illustrated first tine member 14 is substantially solid or non-hollow. It is noted that the first tine member 14 can alternatively be formed in any other suitable manner.

The illustrated second tine or phallic member 16 is a generally cylindrical body having a length 48 extending from the first or base end 44 at the beam member 12 to the second or tip end 46. The second tine member 16 furcates or splits from the beam member 12 at the base end 44 and extends outward from the beam member 12 longitudinally towards the tip end 46. The illustrated second tine member 16 forms an acute angle with the beam member 12 so that the second tine member 16 angles away from the pedicle end 24 of the beam member 12 and angles toward the tip end of the beam member 12 similar to the first tine member 14. The second tine member 16 is spaced apart from the first tine member 14 a distance 42 towards the tip end 26 of the beam member 12. The distance 42 between the second tine member 16 and the first tine member 14 can be in the range of about 3 inches to about 6 inches. The length of the second tine member 16 14 is preferably more than the length of the first tine member 14, and similar to the length of the third tine member 18. The length of the second tine member 16 can be in the range from about 5 inches to about 7 inches and the illustrated second tine member 16 has a length of about 6 inches. The longer second tine member 16 simulates the longer second tine ordinarily found on a typical naturally occurring deer antler (best shown in FIG. 1). The illustrated second tine member 16 has circular-shaped cross section along its entire length 48 and has a suitable diameter 50 for being pleasurably received by a human body cavity such as, for example, a vagina or rectum. The diameter 50 of the second tine member 16 is preferably more than the diameter 40 of the first tine member 14 and similar to the diameter 22 of the beam member 12 and can be in the range of about ½ inch and about 3 inches. Preferably, however, the diameter 50 of the second tine member 16 is similar to the diameter of an average human penis which is in the range of about 1 inch to about 2 inches. It is noted that the second tine member 16 can alternatively have any other suitable sizes and/or shapes such as, for example, different cross sections, different diameters, different lengths, and the like.

The illustrated tip end 46 of the second tine member 16 has a rounded or hemispheric shape. The hemispheric shape promotes insertion into the human body cavity and eases extraction. It is noted that the tip end 46 of the second tine member 16 can alternatively have any other suitable size and/or shape. For example, the tip end 46 of the second tine member 16 may be engorged or bulbous to provide a larger diameter or there here may be a ball or head attached to the tip end 46 to further simulate the appearance of a human penis.

The illustrated second tine member 16 extends in a generally arcuate manner from the base end 44 at the beam member 12 to the tip end 46. The illustrated second tine member 16 has a radius of curvature that is greater than the radius of curvature of the first tine member 16 and less than the radius of curvature of the third tine member 18. The illustrated second tine member 16 has a simple arc or curve in that the longitudinal axis of the second tine member 16 is in a single plane and it is in the same plane as the main beam 12, and the first tine member 14. It is noted, however, that the second tine member 16 can alternatively have a complex arc or curve where the longitudinal axis is not in a single plane and/or can be in a different plane of curvature than the beam member 12 and/or the first tine member 14. It is also noted that the second tine member 16 can alternatively have any other suitable sizes and/or shapes such as, for example, substantially straight, complex curved, or the like.

The illustrated second tine member 16 is substantially solid or non-hollow. It is noted that the second tine member 16 can alternatively be formed in any other suitable manner.

The illustrated third tine or phallic member 18 is a generally cylindrical body having a length 60 extending from the first or base end 56 at the beam member 12 to the second or tip end 58. The third tine member 18 furcates or splits from the beam member 12 at the base end 56 and extends outward from the beam member 12 longitudinally towards the tip end 58. The illustrated third tine member 18 forms an acute angle with the beam member 12 so that the third tine member 18 angles away from the pedicle end 24 of the beam member 12 and angles toward the tip end of the beam member 12 similar to the first tine member 14 and the second tine member 16. The third tine member 18 is spaced apart from the second tine member 16 a distance 54 towards the tip end 26 of the beam member 12. The distance 54 between the third tine member 18 and the second tine member 16 can be in the range of about 3 inches to about 6 inches. The length of the third tine member 18 is preferably more than the length of the first tine member 14, and similar to the length of the second tine member 16. The length of the third tine member 18 can be in the range from about 5 inches to about 7 inches and the illustrated third tine member 18 has a length of about 6 inches. The longer third tine member 18 simulates the longer third tine ordinarily found on a typical naturally occurring deer antler (best shown in FIG. 1). The illustrated third tine member 18 has circular-shaped cross section along its entire length 60 and has a suitable diameter 62 for being pleasurably received by a human body cavity such as, for example, a vagina or rectum. The diameter 62 of the third tine member 18 is preferably more than the diameter 40 of the first tine member 14 and similar to the diameter 22 of the beam member 12 and the second tine member 16 and can be in the range of about ½ inch and about 3 inches. Preferably, however, the diameter 62 of the third tine member 18 is similar to the diameter of an average human penis which is in the range of about 1 inch to about 2 inches. It is noted that the third tine member 18 can alternatively have any other suitable sizes and/or shapes such as, for example, different cross sections, different diameters, different lengths, and the like.

The illustrated tip end 58 of the third tine member 18 has a rounded or hemispheric shape. The hemispheric shape promotes insertion into the human body cavity and eases extraction. It is noted that the tip end 58 of the third tine member 18 can alternatively have any other suitable size and/or shape. For example, the tip end 58 of the third tine member 18 may be engorged or bulbous to provide a larger diameter or there here may be a ball or head attached to the tip end 58 to further simulate the appearance of a human penis.

The illustrated third tine member 18 extends in a generally arcuate manner from the base end 56 at the beam member 12 to the tip end 58. The illustrated third tine member 18 has a radius of curvature that is greater than the radius of curvature of the first and second tine members 14, 16. The illustrated third tine member 18 has a simple arc or curve in that the longitudinal axis of the second tine member 16 is in a single plane and it is in the same plane as the main beam 12, the first tine member 14, and the second tine member 16. It is noted, however, that the third tine member 18 can alternatively have a complex arc or curve where the longitudinal axis is not in a single plane and/or can be in a different plane of curvature than the beam member 12, the first tine member 14, and/or the second tine member 16. It is also noted that the third tine member 18 can alternatively have any other suitable sizes and/or shapes such as, for example, substantially straight, complex curved, or the like.

The illustrated third tine member 18 is substantially solid or non-hollow. It is noted that the third tine member 18 can alternatively be formed in any other suitable manner.

The illustrated beam member 12 extends from the third tine member to the tip end 26 of the beam member for distance 64 in the range of about 8 inches to about 12 inches. It is noted that any other suitable distance can alternatively be utilized. The illustrated first, second and third tine members 14, 16, 18 all extend from the same side of the beam member 12 but alternatively can extend from differing sides. Each of the illustrated first, second, and third members and the tip end 26 of the beam member 12 are configured to have at least one of a different size, a different shape and a different curvature compared to each of the other of the illustrated first, second, and third tine members 14, 16, 18. The illustrated second tine member 16 has a larger radius of curvature, larger diameter, and a larger length than the illustrated first tine member 14. The illustrated third tine member 18 has a larger radius of curvature than the illustrated second tine member 18. The illustrated end portion of the main beam adjacent the tip end 26 has a larger radius of curvature and a larger length than the illustrated third tine member 18. It is noted that alternatively any two or more can be configured to have substantially the same different size, a different shape and a different curvature.

The illustrated erotic stimulation device 10 is a substantially solid body and has a continuous outer surface 66 throughout the device. The illustrated outer surface 66 is moisture resistant and hypo-allergenic. The body is preferably formed of a silicone rubber or the like as ordinarily used by sex toys but any other suitable material can alternatively be utilized such as, for example, glass, wood, plastic, or other conventional known sex toy materials. the additional materials may be engages to a frame if so warranted. It is noted that the body can be constructed in any other suitable manner such as, for example, a skin forming the outer surface and supported around a frame in the form of a deer antler. The outer surface 66 may receive a conventional lubricant as ordinarily used in the sex toy industry. An exemplary lubricant is K-Y Jelly manufactured by Johnson & Johnson of New Brunswick, New Jersey. the outer surface 66 may further come in a variety of colors or patterns. A preferred color is pink, and a preferred pattern is camouflage, however other colors and patterns are contemplated.

As best shown in FIG. 7, the illustrated vibrating device 20 includes a conventional erotic sex toy motor 68. The motor 68 may be of a known type used in silent pagers or other sexual stimulating toys, usually known as vibration motor or a pager motor. For example, the motor can be one identified as “cylindrical DC motor of permanent magnet”, model OTL-6SL, manufactured by Jinglong Machinery & Electronic Co., Ltd. of Yuequing, Zhejiang, China. The illustrated motor 68 generates vibration by spinning an unbalanced weight 70 attached to its motor shaft 72. Suitable conductors 74 conduct current from a power source such as the illustrated battery 21 to the motor 68. A battery holder 78 contains the battery 21 while a vibrator housing 76 contains the motor 68. An on/off switch 80 is provided to selectively connect the battery 21 and the motor 68 to selectively power the motor 21. The on/off switch 80 can be provided on the cap 30 or any other suitable location. The vibrating device 20 is sized and shaped to fit within the cavity or chamber 28 so that vibrations of the vibration device are transferred to the beam member 12 and the plurality of tine members 14, 16, 18. It is noted that the vibrating device 20 can alternatively be of any other suitable type or form.

The illustrated erotic stimulation device 10 is intended to offer sexual stimulation as well as be visually appealing to a person who likes deer antlers or a person who appreciates the creative craftsmanship associated with the erotic industry. The illustrated erotic stimulation device 10 may be displayed without ever being used by a person for sexual stimulation. The illustrated erotic stimulation device 10 may be mounted to a wall or otherwise displayed.

While the foregoing are preferred embodiments, alternative embodiments are contemplated. Alternative embodiments may provide an erotic stimulation device that may penetrate two receiving persons at one time. Similarly, the erotic stimulation device may be configured such that the tine members extend in a manner to allow insertion into a female receiver's vagina and rectum simultaneously. Alternatively, the continuous smooth outer surface may be textured to provide additional pleasure to a user. The textured surface may be knurled, striated, or otherwise deliberately raised as understood in the art to provide pleasure to a user.

In operation, an operator or a partner of an operator may grasp the device 10 anywhere they are capable of generating thrusting and/or reciprocating forces. An operator then may selectively apply conventionally known sexual lubricant to the device 10 or to the human cavity to be penetrated, or both. Operator then aligns the at least one tine or beam member 12, 14, 16, 18 with a desired human cavity they which to penetrate. The human cavity opening engages the hemispheric end of the selected member. The member is then inserted a distance into the human cavity that is pleasurable to the receiving person. after insertion, device 10 may be left in the human cavity for a period of time sexually desirable for the receiving person. Further, device 10 may be reciprocated in and out of the cavity so as to sexually stimulate the receiving person in a manner similar to natural human intercourse. device 10 may continue to be utilized in a reciprocating manner until the receiving person achieves orgasm or otherwise no longer desires to be penetrated by the 3 device 10.

Any of the features or attributes of the above described embodiments and variations can be used in combination with any of the other features and attributes of the above described embodiments and variations as desired.

It is apparent from the above detailed description of preferred embodiments of the present invention, that the elongated tine or phallic members dually function. The tine or phallic members function to simulate the tine of a deer antler while simultaneously simulate a phallic or male sexual member (i.e. penis) for insertion into a human body cavity such as, for example, a vagina, rectum, and the like. It is also apparent that the illustrated device may be used one or more persons at a single time.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. An erotic stimulation device comprising, in combination:
a beam member at least partially extending in a generally arcuate manner between a first end and a second end;
a plurality of tine members spaced apart along the beam member between the first and second ends of the beam member and each outwardly extending from the beam member; and
wherein the beam member and the plurality of tine members are configured to resemble a deer antler.

2. The erotic stimulation device according to claim 1, further comprising a vibrating device operably coupled to the beam member to selectively vibrate the beam member and the plurality of tine members.

3. The erotic stimulation device according to claim 1, wherein the beam member and each of the plurality of tine members are generally circular in cross-section and have a diameter sized for being received by a human body cavity.

4. The erotic stimulation device according to claim 1, wherein at least a portion of the beam member at the second end of the beam member and each of the plurality of tine members are configured to each resemble a human penis.

5. The erotic stimulation device according to claim 1, wherein the plurality of tine members includes a first tine, a second tine, and a third tine.

6. The erotic stimulation device according to claim 5, wherein each of the first, second, and third members are configured to have at least one of a different size and a different shape compared to each of the other of the first, second, and third tine members.

7. The erotic stimulation device according to claim 1, wherein the plurality of tine members each at least partially extend in a generally arcuate manner from the beam member.

8. The erotic stimulation device according to claim 1, wherein the beam member and the plurality of tine members form a continuous outer surface.

9. The erotic stimulation device according to claim 8, wherein the continuous outer surface comprises silicone rubber.

10. A penetrative vibrator for a human body cavity, the penetrative vibrator comprising, in combination:
a beam member at least partially extending in a generally arcuate manner between a first end and a second end;
a plurality of tine members spaced apart along the beam member between the first and second ends of the beam member and each outwardly extending from the beam member;
wherein the beam member and each of the plurality of tine members are configured for being received by the human body cavity; and
a vibrating device operably coupled to the beam member to selectively vibrate the beam member and the plurality of tine members.

11. The penetrative vibrator according to claim 10, wherein the beam member and the plurality of tine members are configured to resemble a deer antler.

12. The penetrative vibrator according to claim 10, wherein the beam member and each of the plurality of tine members are generally circular in cross-section and have a diameter sized for being received by the human body cavity.

13. The penetrative vibrator according to claim 10, wherein at least a portion of the beam member at the second end of the beam member and each of the plurality of tine members are configured to each resemble a human penis.

14. The penetrative vibrator according to claim 10, wherein the plurality of tine members includes a first tine, a second tine, and a third tine.

15. The penetrative vibrator according to claim 14, wherein each of the first, second, and third members are configured to have at least one of a different size and a different shape compared to each of the other of the first, second, and third tine members.

16. The penetrative vibrator according to claim 10, wherein the plurality of tine members each at least partially extend in a generally arcuate manner from the beam member.

17. The penetrative vibrator according to claim 10, wherein the beam member and the plurality of tine members form a continuous outer surface.

18. The penetrative vibrator according to claim 17, wherein the continuous outer surface comprises silicone rubber.

19. A penetrative vibrator for a human body cavity, the penetrative vibrator comprising, in combination:
a beam member at least partially extending in a generally arcuate manner between a first end and a second end;
first, second and third tine members spaced apart along the beam member between the first and second ends of the beam member and each outwardly extending from the beam member;
wherein at least a portion of the beam member at the second end of the beam member and each of the first, second and third tine members are configured for being received by the human body cavity;
a vibrating device operably coupled to the beam member to selectively vibrate the beam member and the first, second, and third tine members; and
wherein the beam member and the first, second and third tine members are configured to resemble a deer antler and at least a portion of the beam member at the second end of the beam member and each of the first, second, and third tine members are configured to each resemble a human penis.

20. The penetrative vibrator according to claim 19, wherein each of the first, second, and third members are configured to have at least one of a different size and a different shape compared to each of the other of the first, second, and third tine members.
